(19) United States
(12) Patent Application Publication
(10) Pub. No.: US 2019/0229581 A1
(43) Pub. Date: Jul. 25, 2019

(54) MOTOR

(71) Applicants: Hyundai Motor Company, Seoul (KR); KIA Motors Corporation, Seoul (KR)

(72) Inventor: Hashimoto TAKENORI, Yokohama-Shi (JP)

(21) Appl. No.: 16/206,228

(22) Filed: Nov. 30, 2018

(30) Foreign Application Priority Data
Jan. 25, 2018 (JP) 2018-010454

(51) Int. Cl. H02K 9/19; H02K 5/24; H02K 1/12

(52) U.S. Cl. CPC H02K 9/19; H02K 1/12; H02K 5/24

(57) ABSTRACT

A motor includes a case, a non-magnetic metal plate, a stator, and a rotor having the cylindrical shape, and the outer circumference of the stator is shrink-fitted into the inner circumference of the non-magnetic metal plate. The non-magnetic metal plate and the case have a flange on one end of the same side thereof, respectively, and both are shrink-fitted in the other end having no flange, and fastened and fixed in at least one bolt hole provided in the flange. The outer circumferential diameter of the central portion of the non-magnetic metal plate is smaller than the inner circumferential diameter of the case, and a cooling flow path having both ends closed is interposed between the non-magnetic metal plate and the case, and a plurality of holes are provided on a part of both ends of the non-magnetic metal plate into which the stator is not shrink-fitted.

### CROSS-REFERENCE TO RELATED APPLICATION

This application claims priority to and the benefit of Japanese Patent Application No. 2018-010454 filed on Jan. 25, 2018, which is incorporated herein by reference in its entirety.

### FIELD

The present disclosure relates to a motor, and more particularly, to an oil cooling type motor.

### BACKGROUND

The statements in this section merely provide background information related disclosure and may not constitute prior art.

A conventional motor for Electric Vehicle (EV) or Hybrid Electric Vehicle (HEV) is mostly an oil cooling type motor using oil (e.g., Automatic Transmission Fluid (ATF)) in order to enhance cooling capability. For example, the oil is blown toward the coil end of the stator through a pipe provided above the stator inside the motor case, and the entire coil is cooled by free fall, known from Japanese Pat. App. Pub. No. 2006-026957. However, since there is a gap in the coil winding, it is difficult to drop the oil around the coil. In addition, since the oil is applied to a part thereof, for example, uneven cooling and temperature deviation in the upper portion and the lower portion of the motor are occurred.

In this regard, there is a method of forcing oil to flow down using an oil pump, known from Japanese Pat. App. Pub. No. 1996-130856 and No. 2005-253263. In both applications, when the oil pump is used, it is desired to securely fix the pipe. However, the fixing structure of the pipe can be broken by vibration. Accordingly, the refrigerant (oil) cannot be supplied at an appropriate location. It results in the reduction in cooling performance, and also it is difficult to compact the fixing structure of the cooling pipe desired from the viewpoint of miniaturization of the device.

In addition, there is a method of using a bracket to fix the pipe, known from Japanese Pat. App. Pub. No. 2004-072950. However, even in this case, it is desired to fix the bracket by the bolt, and as a result, the compactness is sacrificed as much as the space for installing the bolt.

In order to achieve the compactness, a method of providing a flow path (pipe) inside the stator, known from Japanese Pat. App. Pub. No. 1995-298524 or inside the rotor shaft has been proposed. However, in this method, not only the structure related to the flow path becomes complicated, but also the strength of the component and/or the cooling capability can be reduced.

On the other hand, in a motor, particularly, a motor for EV/HEV, suppression of noise is the prerequisite, but upon driving the motor, particularly, we have found that the external noise due to the delivery of the vibration of the stator has the trade-off relationship with the cooling, such that it is difficult to suppress the noise. Conventionally, for example, the stator is fixed by the bolt at three locations with respect to the motor case, known from Japanese Pat. App. Pub. No. 2008-048466, but the stator and the case are contact-fitted, and 30% to 50% of the motor heat-generation due to the contact is delivered to the case to be heat-dissipated to the outside.

On the contrary, due to the contact, we have found that the vibration due to the deformation of the stator upon driving the motor is delivered to the case and radiated from the outer circumference of the case, causing external noise of the motor.

The above information disclosed in this Background section is only for enhancement of understanding of the background of the present disclosure and therefore it may contain information that does not form the prior art that is already known to a person of ordinary skill in the art.

### SUMMARY

The present disclosure provides a compact and low-cost motor structure including better performance of heat dissipation (cooling) and a reduced noise of the motor.

A motor in accordance with the present disclosure includes a case, a non-magnetic metal plate, a stator, and a rotor, which are located concentrically in order from the outside of the motor and have the cylindrical shape at any side thereof. The outer circumference of a central portion of the stator is shrink-fitted into the inner circumference of a central portion of the non-magnetic metal plate. The non-magnetic metal plate and the case have a flange on one end of the same side thereof, respectively, and both are shrink-fitted into the other end having no flange, and fastened and fixed in at least one bolt hole provided in the flange. The outer circumferential diameter of the central portion of the non-magnetic metal plate is smaller than the inner circumferential diameter of the case, and a cooling flow path having both ends closed is interposed between the non-magnetic metal plate and the case. A plurality of holes are provided on a part of both ends of the non-magnetic metal plate, into which the stator is not shrink-fitted, and cooling oil is flowed toward both end portions of the stator and both end portions of the rotor.

Preferably, in accordance with a further aspect of the present disclosure, the stator is formed of a split core, and the non-magnetic metal plate integrates and bundles the split core.

In the motor according to the present disclosure, the non-magnetic metal plate is interposed between the case and the stator, and a gap having both ends sealed is present between the case and the non-magnetic metal plate to form the flow path, such that the heat generated by the stator is mostly absorbed by the oil, and the heat dissipation toward the outside of the case is suppressed due to the absorption of the oil. In addition, the vibration of the stator is mostly damped by the oil, and the external noise by the vibration is also suppressed due to the damped effect.

Furthermore, in the motor according to the present disclosure, as described above, not only the oil is placed in the flow path to absorb the generated heat at the central portion of the stator through the non-magnetic metal plate, but also the oil is flowed through the cooling oil holes provided on both end portions of the non-magnetic metal plate where both end portions of the stator are not shrink-fitted. Accordingly, the flowed oil in the coil end of the both end portions of the stator absorbs the heat, such that it is possible to uniformly dissipate the heat.

In addition, since the stator according to the present disclosure does not have a cantilever structure that is directly fastened by the bolt with respect to the case, known from Japanese Pat. App. Pub. No. 2008-048466, it is possible to easily avoid resonance.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded perspective diagram of a motor in accordance with an exemplary form of the present disclosure; and

FIG. 2 is a main cross-sectional diagram of the motor in accordance with the exemplary form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

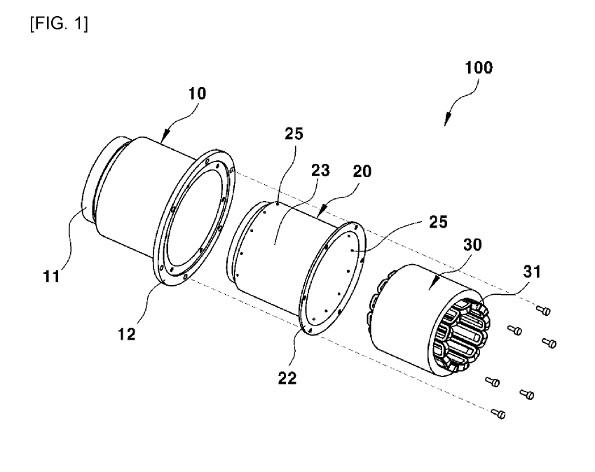

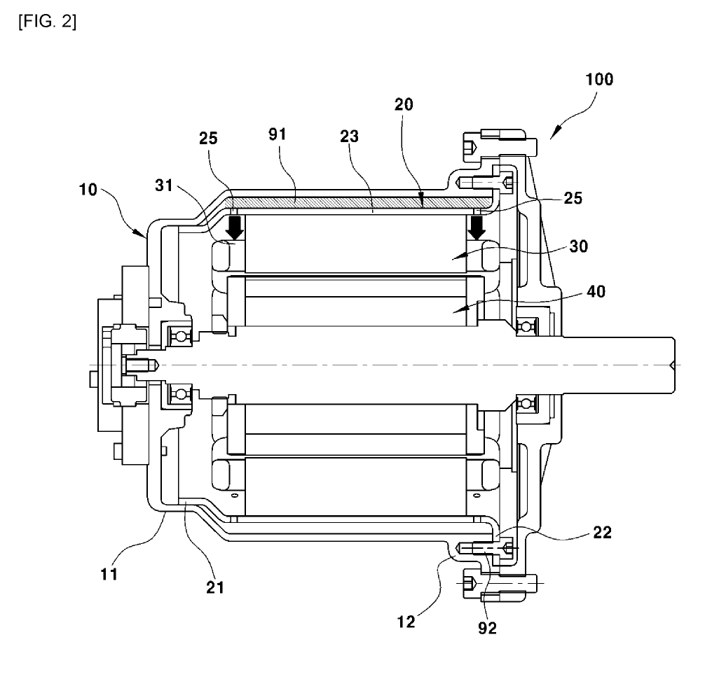

Referring to FIGS. 1 and 2, a motor 100 in accordance with the present disclosure includes, for example, an outermost case 10, a non-magnetic metal plate 20 made of stainless steel, a stator 30, and an innermost rotor 40, all of which are concentric cylindrical shape.

The outer circumference of the central portion of the stator 30 is inserted into the inner circumference of a part of the central portion 23 of the concentric non-magnetic metal plate 20 and is fixed by shrink-fitting.

The non-magnetic metal plate 20 and the case 10 have flanges 22 and 12 on one end of the same side thereof, respectively, are shrink-fitted into the other ends 21 and 11 having no flange, and are fastened and fixed by fastening screws 92 that have passed through bolt holes provided in the flanges 22 and 12.

When the stator 30 is formed of a split core as illustrated in FIG. 2, the non-magnetic metal plate 20 integrates and bundles the split core.

The outer circumferential diameter of the central portion 23 of the non-magnetic metal plate 20 is smaller than the inner circumferential diameter of the case 10, and a cooling flow path 91, which has both ends closed by shrink-fitting or the fastened flange, is interposed between the non-magnetic metal plate 20 and the case 10.

A plurality of cooling oil holes 25 are provided on a part of both end portions of the non-magnetic metal plate 20, into which the stator 30 is not shrink-fitted, and the cooling oil is blown toward both end portions of the stator 30 and both end portions of the rotor 40 through the plurality of cooling oil holes 25 of the non-magnetic metal plate 20.

In the motor in accordance with the present disclosure, the non-magnetic metal plate 20 is interposed between the case 10 and the stator 30, and there is a gap having both ends sealed between the case 10 and the non-magnetic metal plate 20 to form the flow path 91, such that the heat generated by the stator 30 is mostly absorbed by the oil, and the heat dissipation toward the outside of the case 10 is suppressed due to the absorption of the oil. In addition, vibration of the stator 30 is mostly damped by the oil, and the external noise by the vibration is also suppressed due to the damped effect.

In addition, in the motor according to the present disclosure, as described above, not only the oil is placed in the flow path 91 to absorb the heat generated at the central portion of the stator 30 through the non-magnetic metal plate 20, but also the oil is flowed through the cooling oil holes 25 to the coil end 31 of both end portions of the stator 30, which are not shrink-fitted with respect to the central portion of the stator 30 and provided on the opened portion of the stator 30 for absorbing the generated heat, thus uniformly dissipating the heat.

The disclosure related to this motor is not limited to the motor for EV/HEV and can be applied to a general motor, but particularly, it is possible to reduce the heat resistance of a rare earth magnet, which occupies most of the cost of the motor for EV/HEV, thus remarkably reducing the cost of the motor.

While this present disclosure has been described in connection with what is presently considered to be practical exemplary forms, it is to be understood that the present disclosure is not limited to the disclosed forms, but, on the contrary, is intended to cover various modification and equivalent arrangements included within the spirit and scope of the present disclosure.

What is claimed is:

1. A motor, comprising:
a case, a non-magnetic metal plate, a stator, and a rotor located concentrically in order from an outside of the motor and having a cylindrical shape at any side thereof,
wherein an outer circumference of a central portion of the stator is shrink-fitted into an inner circumference of a central portion of the non-magnetic metal plate,
wherein the non-magnetic metal plate and the case have a flange on one end of the same side thereof, respectively, and both are shrink-fitted into another end having no flange, and fastened and fixed in at least one bolt hole provided in the flange,
wherein an outer circumferential diameter of the central portion of the non-magnetic metal plate is smaller than an inner circumferential diameter of the case, and a cooling flow path having both ends closed is interposed between the non-magnetic metal plate and the case, and
wherein a plurality of holes are provided on a part of both ends of the non-magnetic metal plate into which the stator is not shrink-fitted, and cooling oil is flowed toward both end portions of the stator and both end portions of the rotor.

2. The motor of claim 1, wherein the stator is formed of a split core, and the non-magnetic metal plate integrates and bundles the split core.
